(19) United States
(12) Patent Application Publication
(10) Pub. No.: US 2024/0068513 A1
(43) Pub. Date: Feb. 29, 2024

(54) AXIAL RADIAL BEARING

(71) Applicant: Schaeffler Technologies AG & Co. KG, Herzogenaurach (DE)

(72) Inventors: Dennis Roffe, Fort Mill, SC (US); Michael Heaton, Rock Hill, SC (US)

(73) Assignee: Schaeffler Technologies AG & Co. KG, Herzogenaurach (DE)

(21) Appl. No.: 17/893,598

(22) Filed: Aug. 23, 2022

(51) Int. Cl. F16C 19/49; F16C 33/60

(52) U.S. Cl. CPC F16C 19/49; F16C 33/60

(57) ABSTRACT

A bearing assembly includes an inner ring and an outer ring arranged coaxially with the inner ring. A first axial washer and a second axial washer are axially spaced from each other. A central ring is disposed radially between the inner ring and the outer ring and axially between the first axial washer and the second axial washer. Four rows of rolling bodies are provided. The rolling bodies in each row are engaged with the central ring. Each of the inner ring, the outer ring, the first axial washer, and the second axial washer are engaged with the rolling bodies of one respective row.

### TECHNICAL FIELD

The present disclosure relates generally to a bearing assembly, and more specifically to an axial radial bearing.

### BACKGROUND

A bearing assembly may include two bearings each being configured to support loading in one respective direction, e.g., radial or axial. That is, one bearing may be configured to support radial loading, and the other bearing may be configured to support axial loading. However, having two separate bearings each configured to support separate loads adds cost and complexity to the bearing assembly. Further, due to limited spacing, e.g., within an e-motor, it is desirable to have alternative designs and configurations that can fit between rotating components and support loads in multiple directions. Moreover, as envelope spacing and packaging become more limited, issues may arise with manufacturing various components to meet these reduced tolerances.

### SUMMARY

Embodiments of this disclosure provide a bearing assembly including an inner ring and an outer ring arranged concentrically with the inner ring. The bearing assembly further includes a first axial washer and a second axial washer axially spaced from each other. The bearing assembly further includes a central ring disposed radially between the inner ring and the outer ring and axially between the first axial washer and the second axial washer. The bearing assembly further includes four rows of rolling bodies. The rolling bodies in each row are engaged with the central ring. Each of the inner ring, the outer ring, the first axial washer, and the second axial washer are engaged with the rolling bodies of one respective row.

In embodiments, the four rows of rolling bodies may include a first row of rolling bodies disposed between the central ring and the outer ring, a second row of rolling bodies disposed between the central ring and the inner ring, a third row of rolling bodies disposed between the central ring and the first axial washer, and a fourth row of rolling bodies disposed between the central ring and the second axial washer. The rolling bodies of the first row and the second row may be a same type of rolling body. The rolling bodies of the first and second rows may be ball bearings. The rolling bodies of the third row and the fourth row may be a same type of rolling body. The rolling bodies of the third and fourth rows may be cylindrical rollers. The rolling bodies of the first row and the second row may be a same type of rolling body, and the rolling bodies of the first row may be a different type of rolling body than the rolling bodies of the third row and the rolling bodies of the fourth row.

In embodiments, the first axial washer may extend from one of the outer ring or the inner ring. The second axial washer may extend from the other of the outer ring or the inner ring. In embodiments, the first and second axial washers may be radially spaced from the inner ring and the outer ring.

Embodiments of this disclosure further provide an assembly including a first machine element and a second machine element rotatable relative to the first machine element. The first and second machine elements are arranged concentrically with each other. The assembly further includes an inner ring connected to the first machine element, and an outer ring connected to the second machine element. The assembly further includes a first axial washer and a second axial washer axially spaced from each other. The assembly further includes a central ring disposed radially between the inner ring and the outer ring and axially between the first axial washer and the second axial washer. The assembly further includes four rows of rolling bodies. The rolling bodies in each row are engaged with the central ring. Each of the inner ring, the outer ring, the first axial washer, and the second axial washer are engaged with the rolling bodies of one respective row.

In embodiments, the first machine element may be one of a shaft or a housing, and the second machine element may be the other of the shaft or the housing. In embodiments, the first axial washer may be engaged with one of the first machine element or the second machine element, and the second axial washer may be engaged with the other of the first machine element or the second machine element.

In embodiments, the four rows of rolling bodies may include a first row of rolling bodies disposed between the central ring and the outer ring, a second row of rolling bodies disposed between the central ring and the inner ring, a third row of rolling bodies disposed between the central ring and the first axial washer, and a fourth row of rolling bodies disposed between the central ring and the second axial washer. The rolling bodies of the first row may be ball bearings, and the rolling bodies of the second row may be ball bearings. The rolling bodies of the third row may be cylindrical rollers, and the rolling bodies of the fourth row may be cylindrical rollers. The rolling bodies of the first row and the second row may be a same type of rolling body, and the rolling bodies of the first row may be a different type of rolling body than the rolling bodies of the third row and the rolling bodies of the fourth row.

In embodiments, the first axial washer may extend from one of the outer ring or the inner ring. The second axial washer may extend from the other of the outer ring or the inner ring. In embodiments, the first and second axial washers may be radially spaced from the inner ring and the outer ring.

### BRIEF DESCRIPTION OF THE DRAWINGS

FIG. 1 illustrates a partial view of a cross section through one embodiment of a bearing assembly according to the present disclosure.

FIG. 2 illustrates a partial view of a cross section through an assembly including the bearing assembly shown in FIG. 1.

FIG. 3 illustrates a partial view of a cross section through another embodiment of a bearing assembly according to the present disclosure.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

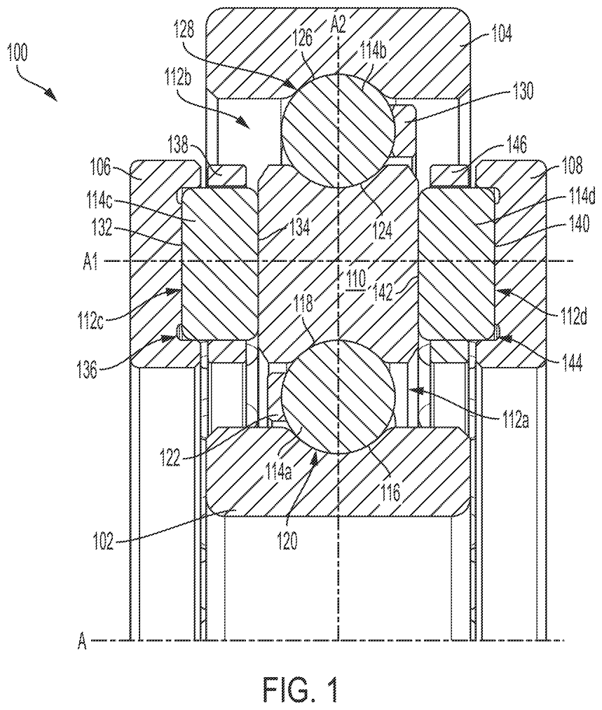

Referring to FIGS. 1-3, a portion of a bearing assembly 100 is illustrated according to one embodiment of the present disclosure. At least some portions of the bearing assembly 100 are rotatable about a central axis A. While only a portion of the bearing assembly 100 above the central axis A is shown in FIG. 1, it should be understood that the bearing assembly 100 can appear substantially similar below the central axis A with many components extending about the central axis A. Words such as “axial,” “radial,” “circumferential,” “outward,” etc. as used herein are intended to be with respect to the central axis A.

The bearing assembly 100 includes: an inner ring 102; an outer ring 104 arranged concentrically with the inner ring 102; a first axial washer 106; a second axial washer 108 axially spaced from the first axial washer 106; a central ring 110 disposed radially between the inner ring 102 and the outer ring 104 and axially between the first axial washer 106 and the second axial washer 108; and four rows 112 of rolling bodies 114. The rolling bodies 114 of each row 112 are engaged with the central ring 110. Each of the inner ring 102, the outer ring 104, the first axial washer 106, and the second axial washer 108 are engaged with the rolling bodies 114 of one respective row 112.

Embodiments described herein include advantageous configurations that include configuring the central ring 110 to provide races for two radially spaced rows of rolling bodies and two axially spaced rows of rolling bodies, which allows for packaging of the bearing assembly 100 in smaller envelopes. Additionally, providing races for two radially spaced rows of rolling bodies and two axially spaced rows of rolling bodies allows the bearing assembly 100 to support axial and radial loads applied to the bearing assembly 100. Accordingly, the bearing assembly 100 may be referred to as an “axial radial bearing.”

Turning to FIG. 1, the bearing assembly 100 includes a first row 112a of rolling bodies 114a disposed between the central ring 110 and the inner ring 102. The rolling bodies 114a of the first row 112a may be circumferentially spaced from each other. For example, the rolling bodies 114a of the first row 112a may be uniformly spaced from each other about the central axis A. The rolling bodies 114a of the first row 112a engage the central ring 110 and the inner ring 102. The central ring 110 defines an outer race 118 on a radial inner surface thereof, and the inner ring 102 defines an inner race 116 on a radial outer surface thereof. The inner and outer races 116, 18 define a track 120 therebetween. The track 120 is configured to house the rolling bodies 114a of the first row 112a.

The rolling bodies 114a of the first row 112a may be configured to support radial loads applied to the bearing assembly 100. The rolling bodies 114a of the first row 112a may, for example, be ball bearings. Alternatively, the rolling bodies 114a of the first row 112a may be any other suitable type of rolling body for supporting radial loads.

The bearing assembly 100 may include a first cage 122 disposed between the central ring 110 and the inner ring 102. The rolling bodies 114a of the first row 112a may be supported by the first cage 122.

The bearing assembly 100 includes a second row 112b of rolling bodies 114b disposed between the central ring 110 and the outer ring 104. The rolling bodies 114b of the second row 112b may be circumferentially spaced from each other. For example, the rolling bodies 114b of the second row 112b may be uniformly spaced from each other about the central axis A. The rolling bodies 114b of the second row 112b engage the central ring 110 and the outer ring 104. The central ring 110 defines an inner race 124 on a radial outer surface thereof, and the outer ring 104 defines an outer race 126 on a radial inner surface thereof. The inner and outer races 124, 126 define a track 128 therebetween. The track 128 is configured to receive the rolling bodies 114b of the second row 112b.

The track 128 may be substantially identical to the track 120. That is, the track 128 may be designed, i.e., sized and shaped, the same as the track 120. For example, the track 128 may be a mirror image of the track 120 relative to an axis A1 parallel to and radially spaced from the central axis A. Alternatively, the track 128 may be designed differently than the track 120.

The rolling bodies 114b of the second row 112b may be configured to support radial loads applied to the bearing assembly 100. For example, the rolling bodies 114b of the second row 112b may be a same type of rolling body as the rolling bodies 114a of the first row 112a, e.g., ball bearings. The rolling bodies 114b of the second row 112b may be substantially identical to the rolling bodies 114a of the first row 112a. That is, the rolling bodies 114b of the second row 112b may be designed, i.e., sized and shaped, the same as the rolling bodies 114a of the first row 112a. For example, the rolling bodies 114b of the second row 112b may be mirror images of the rolling bodies 114a of the first row 112a relative to the axis A1. Alternatively, the rolling bodies 114b of the second row 112b may be designed differently than the rolling bodies 114a of the first row 112a, e.g., when the tracks 120, 128 are designed differently.

The bearing assembly 100 may include a second cage 130 disposed between the central ring 110 and the outer ring 104. The rolling bodies 114b of the second row 112b may be supported by the second cage 130. The second cage 130 may be a mirror image of the first cage 122 relative to an axis A2 extending perpendicular to the central axis A.

The bearing assembly 100 includes a third row 112c of rolling bodies 114c disposed between the central ring 110 and the first axial washer 106. The first axial washer 106 may be radially disposed between the inner ring 102 and the outer ring 104. The first axial washer 106 may be radially spaced from the inner ring 102 and/or the outer ring 104. For example, the first axial washer 106 may be formed separately from the inner ring 102 and the outer ring 104 and subsequently assembled to the bearing assembly 100.

The rolling bodies 114c of the third row 112c may be circumferentially spaced from each other. For example, the rolling bodies 114c of the third row 112c may be uniformly spaced from each other about the central axis A. The rolling bodies 114c of the third row 112c engage the central ring 110 and the first axial washer 106. The central ring 110 defines a first race 132 on a first axial surface thereof, and the first axial washer 106 defines a second race 134 on an axial surface (e.g., facing the central ring 110) thereof. The first and second races 132, 134 define a track 136 therebetween. The track 136 is configured to receive the rolling bodies 114c of the third row 112c.

The rolling bodies 114c of the third row 112c may be configured to support axial loads applied to the bearing assembly 100. The rolling bodies 114c of the third row 112c may, for example, be cylindrical bearings. Alternatively, the rolling bodies 114c of the third row 112c may be any other suitable type of rolling body for supporting axial loads. The rolling bodies 114c of the third row 112c may be a different type of rolling body than the rolling bodies 114a of the first row 112a and the rolling bodies 114b of the second row 112b.

The bearing assembly 100 may include a third cage 138 disposed between the central ring 110 and the first axial washer 106. The rolling bodies 114c of the third row 112c may be supported by the third cage 138.

The bearing assembly 100 includes a fourth row 112d of rolling bodies 114d disposed between the central ring 110 and the second axial washer 108. The second axial washer 108 is arranged concentrically with the first axial washer 106. The second axial washer 108 may be radially aligned with the first axial washer 106. The second axial washer 108 may be a mirror image of the first axial washer 106 relative to the axis A2. The second axial washer 108 may be radially disposed between the inner ring 102 and the outer ring 104. The second axial washer 108 may be radially spaced from the inner ring 102 and/or the outer ring 104. For example, the second axial washer 108 may be formed separately from the inner ring 102 and the outer ring 104 and subsequently assembled to the bearing assembly 100.

The rolling bodies 114d of the fourth row 112d may be circumferentially spaced from each other. For example, the rolling bodies 114d of the fourth row 112d may be uniformly spaced from each other about the central axis A. The rolling bodies 114d of the fourth row 112d engage the central ring 110 and the second axial washer 108. The central ring 110 defines an inner race 140 on a second axial surface (e.g., opposite the first axial surface) thereof, and the second axial washer 108 defines an outer race 142 on an axial surface (e.g., facing the central ring 110) thereof. The inner and outer races 140, 142 define a track 144 therebetween. The track 144 is configured to receive the rolling bodies 114d of the fourth row 112d.

The track 144 may be substantially identical to the track 136. That is, the track 144 may be designed, i.e., sized and shaped, the same as the track 136. For example, the track 144 may be a mirror image of the track 136 relative to the axis A2. Alternatively, the track 144 may be designed differently than the track 136.

The rolling bodies 114d of the fourth row 112d may be configured to support axial loads applied to the bearing assembly 100. For example, the rolling bodies 114d of the fourth row 112d may be a same type of rolling body as the rolling bodies 114c of the third row 112c, e.g., cylindrical bearings. The rolling bodies 114d of the fourth row 112d may be substantially identical to the rolling bodies 114c of the third row 112c. That is, the rolling bodies 114d of the fourth row 112d may be designed, i.e., sized and shaped, the same as the rolling bodies 114c of the third row 112c. For example, the rolling bodies 114d of the fourth row 112d may be a mirror image of the rolling bodies 114c of the third row 112c relative to the axis A2. Alternatively, the rolling bodies 114d of the fourth row 112d may be designed differently than the rolling bodies 114c of the third row 112c, e.g., when the tracks 136, 144 are designed differently.

The bearing assembly 100 may include a fourth cage 146 disposed between the central ring 110 and the second axial washer 108. The rolling bodies 114d of the fourth row 112d may be supported by the fourth cage 146. The fourth cage 146 may be a mirror image of the third cage 138 relative to the axis A2.

The bearing assembly 100 may include one or more covers (not shown). The cover(s) may extend radially from one of the inner ring 102 or the outer ring 104 to one of the first axial washer 106 or the second axial washer 108. As one example, each cover may be fixed to one of the inner ring 102 or the outer ring 104 and be rotatable relative to the first and second axial washers 106, 108. As another example, each cover may be fixed to one of the first axial washer 106 or the second axial washer 1084 and be rotatable relative to the inner and outer rings 102, 104. The cover(s) may be configured to prevent debris from entering one or more tracks 120,128, 136, 144.

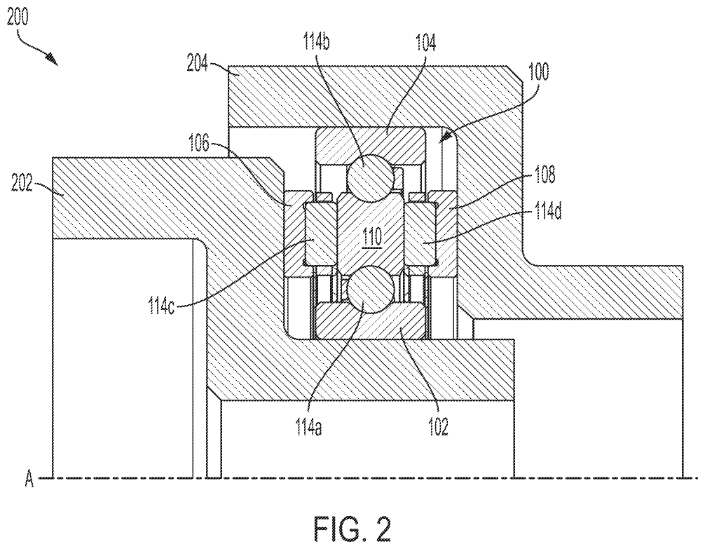

Turning now to FIG. 2, an assembly 200 may include a first machine element 202; a second machine element 204; and the bearing assembly 100. The first and second machine elements 202, 204 are arranged concentrically with each other. The second machine element 204 is rotatable relative to the first machine element 202. For example, the first machine element 202 may be one of a housing or a shaft, and the second machine element 204 may be the other of the housing or the shaft.

The first machine element 202 is connected, e.g., via a press-fit connection, to the inner ring 102, and the second machine element 204 is connected, e.g., via a slip-fit connection, to the outer ring 104. That is, the first machine element 202 is designed, i.e., sized and shaped, to be received by the inner ring 102, and the second machine element 204 is designed to receive the outer ring 104. Said differently, the first machine element 202 may apply loads to the bearing assembly 100 in a radially outward direction, and the second machine element 204 may apply loads to the bearing assembly 100 in a radially inward direction.

The first machine element 202 may be engaged with one of the first axial washer 106 or the second axial washer 108. For example, the bearing assembly 100 may be arranged on the first machine element 202 such that one of the first axial washer 106 or the second axial washer 108 abuts an axial surface of the first machine element 202. That is, the first machine element 202 may apply loads to the bearing assembly 100 in a first axial direction.

The second machine element 204 may be engaged with the other of the first axial washer 106 or the second axial washer 108. For example, the second machine element 204 may be arranged on the bearing assembly 100 such that the other of the first axial washer 106 or the second axial washer 108 abuts an axial surface of the second machine element 204. That is, the second machine element 204 may apply loads to the bearing assembly 100 in a second, opposite axial direction.

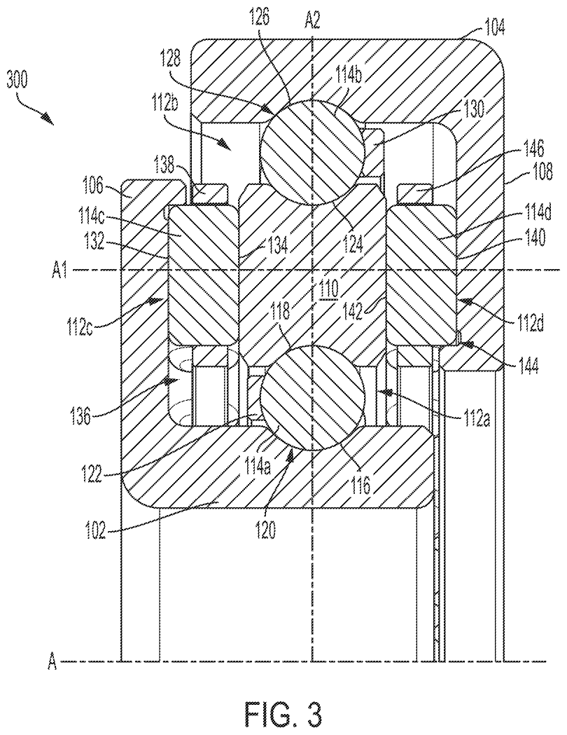

Referring to FIG. 3, an alternative embodiment for a bearing assembly 300 is provided. In contrast to FIGS. 1-2, the first axial washer 106 extends from one of the inner ring 102 or the outer ring 104. Additionally, the second axial washer 108 extends from the other of the inner ring 102 or the outer ring 104. In the example embodiment shown in FIG. 3, the first axial washer 106 extends from the inner ring 102 and is radially spaced from the outer ring 104, and the second axial washer 108 extends from the outer ring 104 and is radially spaced from the inner ring 102. In such an example, the first axial washer 106 may be formed integrally with the inner ring 102, and the second axial washer 108 may be formed integrally with the outer ring 104. As another example, the first axial washer 106 may be formed separately from and subsequently connected to the inner ring 102, and the second axial washer 108 may be formed separately from and subsequently connected to the outer ring 104. The bearing assembly 100 may include a cover (not shown) extending from the first axial washer 106 to the outer ring 104. Additionally, or alternatively, the bearing assembly 100 may include a further cover (not shown) extending from the second axial washer 108 to the inner ring 102.

Extending the first axial washer 106 from one of the inner or outer rings 102, 104, and extending the second axial washer 108 from the other of the inner or outer rings 102, 104 allows for reducing a likelihood of debris entering the tracks 120,128, 136, 144 by covering a portion of the tracks 120,128, 136, 144 from an environment around the bearing assembly 100. Further, extending the first axial washer 106 from one of the inner or outer rings 102, 104, and extending the second axial washer 108 from the other of the inner or outer rings 102, 104 may reduce cost and complexity of the bearing assembly 100 by reducing a number of covers for the bearing assembly 100.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 bearing assembly
102 inner ring
104 outer ring
106 first axial washer
108 second axial washer
110 central ring
112 row
114 rolling body
116 outer race
118 inner race
120 track
122 first cage
124 inner race
126 outer race
128 track
130 second cage
132 first race
134 second race
136 track
138 third cage
140 first race
142 second race
144 track
146 fourth cage
200 assembly
202 first machine element
204 second machine element
300 bearing assembly
A central axis
A1 axis
A2 axis

What is claimed is:

1. A bearing assembly, comprising:
an inner ring and an outer ring arranged concentrically with the inner ring;
a first axial washer and a second axial washer axially spaced from each other;
a central ring disposed radially between the inner ring and the outer ring and axially between the first axial washer and the second axial washer; and
four rows of rolling bodies, the rolling bodies in each row being engaged with the central ring, and each of the inner ring, the outer ring, the first axial washer, and the second axial washer being engaged with the rolling bodies of one respective row.

2. The bearing assembly of claim 1, wherein the four rows of rolling bodies includes a first row of rolling bodies disposed between the central ring and the outer ring, a second row of rolling bodies disposed between the central ring and the inner ring, a third row of rolling bodies disposed between the central ring and the first axial washer, and a fourth row of rolling bodies disposed between the central ring and the second axial washer.

3. The bearing assembly of claim 2, wherein the rolling bodies of the first row and the second row are a same type of rolling body.

4. The bearing assembly of claim 3, wherein the rolling bodies of the first and second rows are ball bearings.

5. The bearing assembly of claim 2, wherein the rolling bodies of the third row and the fourth row are a same type of rolling body.

6. The bearing assembly of claim 5, wherein the rolling bodies of the third and fourth rows are cylindrical rollers.

7. The bearing assembly of claim 2, wherein the rolling bodies of the first row and the second row are a same type of rolling body, and the rolling bodies of the first row are a different type of rolling body than the rolling bodies of the third row and the rolling bodies of the fourth row.

8. The bearing assembly of claim 1, wherein the first axial washer extends from one of the outer ring or the inner ring.

9. The bearing assembly of claim 8, wherein the second axial washer extends from the other of the outer ring or the inner ring.

10. The bearing assembly of claim 1, wherein the first and second axial washers are radially spaced from the inner ring and the outer ring.

11. An assembly, comprising:
a first machine element and a second machine element rotatable relative to the first machine element, the first and second machine elements being arranged concentrically with each other;
an inner ring connected to the first machine element and an outer ring connected to the second machine element;
a first axial washer and a second axial washer axially spaced from each other;
a central ring disposed radially between the inner ring and the outer ring and axially between the first axial washer and the second axial washer; and
four rows of rolling bodies, the rolling bodies in each row being engaged with the central ring, and each of the inner ring, the outer ring, the first axial washer, and the second axial washer being engaged with the rolling bodies of one respective row.

12. The assembly of claim 11, wherein the first machine element is one of a shaft or a housing, and the second machine element is the other of the shaft or the housing.

13. The assembly of claim 11, wherein the first axial washer is engaged with one of the first machine element or the second machine element, and the second axial washer is engaged with the other of the first machine element or the second machine element.

14. The assembly of claim 11, wherein the four rows of rolling bodies includes a first row of rolling bodies disposed between the central ring and the outer ring, a second row of rolling bodies disposed between the central ring and the inner ring, a third row of rolling bodies disposed between the central ring and the first axial washer, and a fourth row of rolling bodies disposed between the central ring and the second axial washer.

15. The assembly of claim 14, wherein the rolling bodies of the first row are ball bearings, and the rolling bodies of the second row are ball bearings.

16. The assembly of claim 14, wherein the rolling bodies of the third row are cylindrical rollers, and the rolling bodies of the fourth row are cylindrical rollers.

17. The assembly of claim 14, wherein the rolling bodies of the first row and the second row are a same type of rolling body, and the rolling bodies of the first row are a different type of rolling body than the rolling bodies of the third row and the rolling bodies of the fourth row.

18. The assembly of claim 11, wherein the first axial washer extends from one of the outer ring or the inner ring.

19. The assembly of claim 18, wherein the second axial washer extends from the other of the outer ring or the inner ring.

20. The assembly of claim 11, wherein the first and second axial washers are radially spaced from the inner ring and the outer ring.
